(19) United States
(12) Patent Application Publication
(10) Pub. No.: US 2004/0227839 A1
(43) Pub. Date: Nov. 18, 2004

(54) Systems and methods for determining focus from light collected by the periphery of a lens

(76) Inventors: Donald J. Stavely, Windsor, CO (US); Christopher A. Whitman, Fort Collins, CO (US); Robert E. Sobol, Ft. Collins, CO (US); Kevin J. Matherson, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/437,358

(22) Filed: May 13, 2003

(51) Int. Cl. H04N 5/232

(52) U.S. Cl. 348/345

(57) ABSTRACT

Disclosed are systems and methods for determining focus of an image. In one embodiment, a system and a method pertains to restricting light provided by a central portion of a camera lens so that light is primarily collected from a periphery of the lens, and evaluating the focus of the image using the light from the periphery of the lens.

### BACKGROUND

Autofocus has become a standard feature on both film and digital cameras. Despite years of innovation and development, the autofocus feature has attendant drawbacks that often result in out-of-focus images being captured, especially in low light conditions and/or when scenes of low spatial contrast are captured.

In most autofocus methods, a camera lens or lens system is moved axially between several different focus positions, and the sharpness of the observed scene (image) is evaluated at each position. In this process, a focus value is derived for each focus position and the values are compared to determine the focus position at which the image is most in focus. For instance, in digital cameras, a summing function in which the absolute value or the square of the differences between light values of adjacent sensor pixels are added together, can be used to identify the focus position that has the greatest contrast (i.e., highest summed value), thereby indicating the sharpest focus. The focus value that is derived for each focus position is typically a measure of horizontal contrast, vertical contrast, or a combination of the two.

The accuracy with which the focus determination is made depends, at least in part, upon the source of the light that is used to make the determination. Generally speaking, the rays of light that enter the camera through the center of the camera lens contribute less to the autofocus determination than do those that enter through the periphery of the lens. This fact can be appreciated when the manner in which aperture affects depth of focus is considered. FIG. 1 illustrates a prior art aperture wheel 100 that comprises a plurality of circular aperture openings 102 having different diameters. In use, the aperture wheel 100 is rotated such that different aperture openings 102 may be placed along the path of light between the camera lens and the light sensitive medium (i.e. film or light sensor). When a relatively large aperture opening 102 is used, the depth of focus, i.e. the range of distances from the camera lens in which objects are in focus at any given time, is small such that different focus positions yield significantly different focus values. When a relatively small aperture opening is used, however, the depth of focus is large such that the different focus positions yield more similar focus values, thereby making the focus determination more difficult. Smaller apertures also tend to increase the system signal-to-ratio. In such a case, it is more likely that the camera will identify “false peaks” of the focus values, which may result in poorly focused images.

Although improved focus determinations can be made when a large aperture is used so that light collected from the periphery of the camera lens is used to make the focus determinations, the light collected from the center of the lens is still collected and adversely affects the accuracy of the determination. The reason for this is that camera resources (e.g., full well capacity, signal range) that could be utilized to analyze light signals that contain the information most useful to the focus determination are wasted analyzing light signals that contain the least useful information. Accordingly, it would be desirable to have autofocus systems and methods that determine focus based primarily upon light collected around the periphery of the camera lens as opposed to that collected from the center of the lens.

### SUMMARY

Disclosed are systems and methods for determining focus of an image. In one embodiment, a system and a method pertains to restricting light provided by a central portion of a camera lens so that light is primarily collected from a periphery of the lens, and evaluating the focus of the image using the light from the periphery of the lens.

### BRIEF DESCRIPTION OF THE DRAWINGS

The disclosed systems and methods can be better understood with reference to the following drawings. The components in the drawings are not necessarily to scale.

FIG. 1 is front view of an example prior art aperture wheel.

FIG. 2 is a block diagram of an embodiment of a camera that comprises an autofocus system that determines focus based upon light collected from the periphery of a camera lens.

FIG. 3 is a flow diagram illustrating an embodiment of a method for focusing an image based upon light collected from the periphery of a camera lens.

FIG. 4 is a schematic perspective view that depicts alignment of an autofocus aperture with a light path within a camera.

FIGS. 5A-5G are front views of various embodiments of aperture members that may be used in the autofocus system of FIG. 4.

### DETAILED DESCRIPTION

As identified in the foregoing, the light collected from the center of a camera lens adversely affects the accuracy of the focus determination in that camera resources are wasted analyzing light signals that contain little information that is useful to the focus determination. Improved focusing can be achieved, however, when the light collected from the periphery of the camera lens, as opposed to that collected from the central portion of the lens, is used to make the focus determination. As is described in greater detail below, such a result can be obtained through use of a non-circular aperture that filters light collected from the central portion of the lens so that only light collected from the periphery of the lens is used during the focus determination.

Disclosed herein are embodiments of systems and methods that determine focus based upon light collected from the periphery of a camera lens. Although particular embodiments are disclosed, these embodiments are provided for purposes of example only to facilitate description of the disclosed systems and methods. Accordingly, other embodiments are possible.

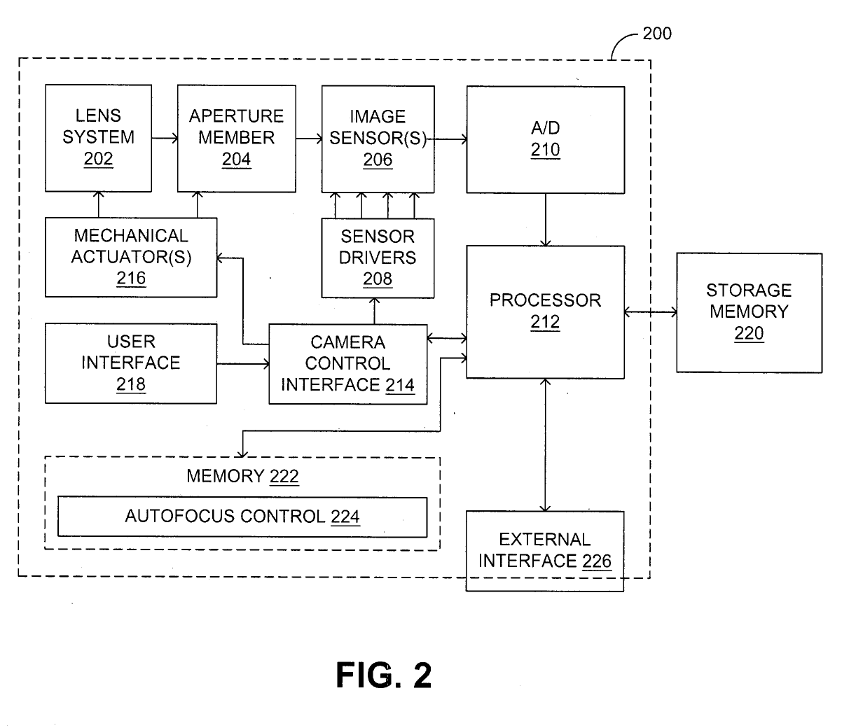

Referring now to the drawings, in which like numerals indicate corresponding parts throughout the several views, FIG. 2 illustrates an embodiment of a camera 200 that is configured to determine focus based upon light collected from the periphery of a camera lens. In the example of FIG. 2, the camera 200 is configured as a digital camera. Although a digital camera is illustrated in FIG. 2 and explicitly discussed herein, the camera 200 can alternatively comprise any camera in which improved autofocusing is desired.

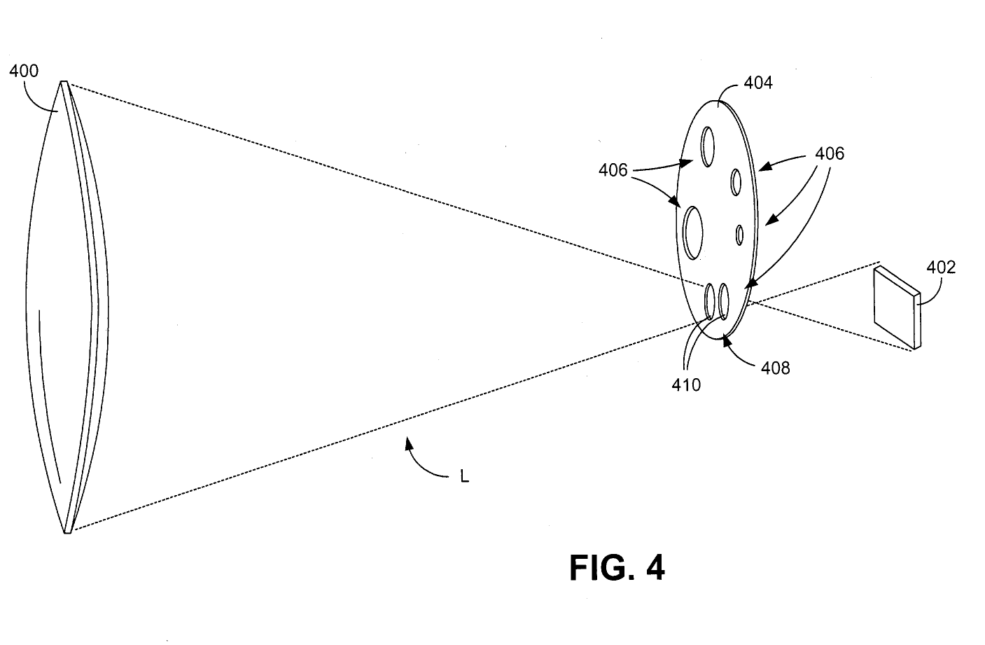

As indicated FIG. 2, the camera 200 includes a lens system 202 that conveys images of viewed scenes to an image sensor 206 via an aperture member 204 (see FIG. 4). The lens system 202 comprises one or more lenses that collect light from the viewed scene. A portion of this light is intercepted by the aperture member 204 such that the aperture member restricts the amount of light that reaches the image sensor 206. As is described in the following, the aperture member 204 can, for example, comprise an aperture wheel comprising a plurality of aperture openings.

The image sensor 206 comprises one or more light-sensitive elements, such as elements of a charge-coupled device (CCD) or a complimentary metal oxide semiconductor (CMOS) sensor, that are driven by one or more sensor drivers 208. The analog image signals captured by the image sensor 206 are then provided to an analog-to-digital (A/D) converter 210 for conversion into binary code that can be processed by a processor 212.

Operation of the sensor driver(s) 208 is controlled through a camera control interface 214 that is in bi-directional communication with the processor 212. Also controlled through the interface 214 are one or more mechanical actuators 216 that are used to control operation of the lens system 202 as well as the aperture member 204. These actuators 214 include, for instance, motors that move the lenses of the lens system 202 and rotate the aperture member (e.g., wheel) 204. Operation of the camera control interface 214 may be adjusted through manipulation of a user interface 218. The user interface 218 comprises the various components used to enter selections and commands into the camera 200 such as a shutter-release button and various control buttons provided on the camera.

Captured digital images may be stored in storage memory 220, such as that contained within a removable solid-state memory card (e.g., Flash memory card). In addition to this memory, the camera comprises permanent (i.e., non-volatile) memory 222 that includes an autofocus control 224, which is used to manipulate the aperture member 204 and make autofocus determinations. Although the autofocus control 224 is illustrated as being contained within device memory 222, the system and/or its functionality can alternatively be integrated into the processor 212 and/or control interface 214, if desired.

In addition to the aforementioned components, the camera 200 may comprise an external interface 226 through which data (e.g., images) may be transmitted to another device, such as a desktop personal computer (PC). By way of example, this interface 226 comprises a universal serial bus (USB) connector.

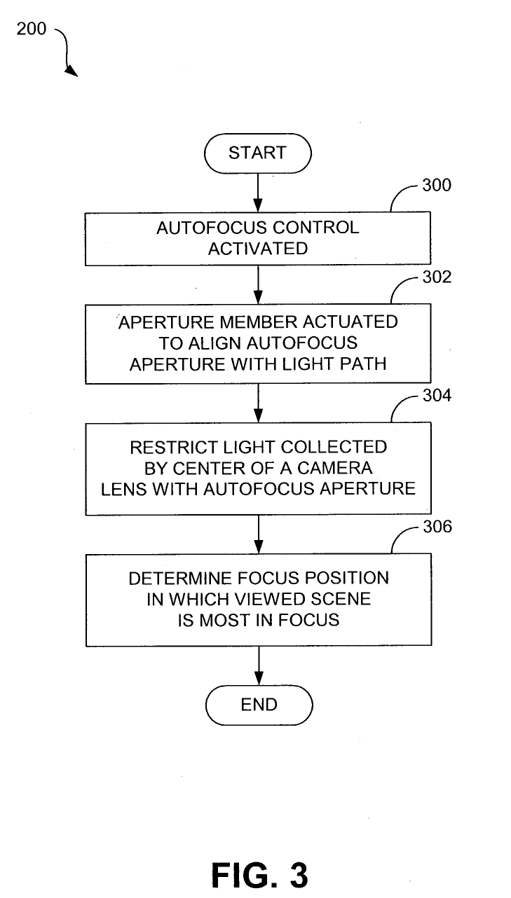

FIG. 3 illustrates an embodiment of a method for focusing an image based upon light collected from the periphery of a camera lens, for instance a lens of the lens system 202 identified in FIG. 2. It is noted that any process steps or blocks described in the flow diagrams of this disclosure may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

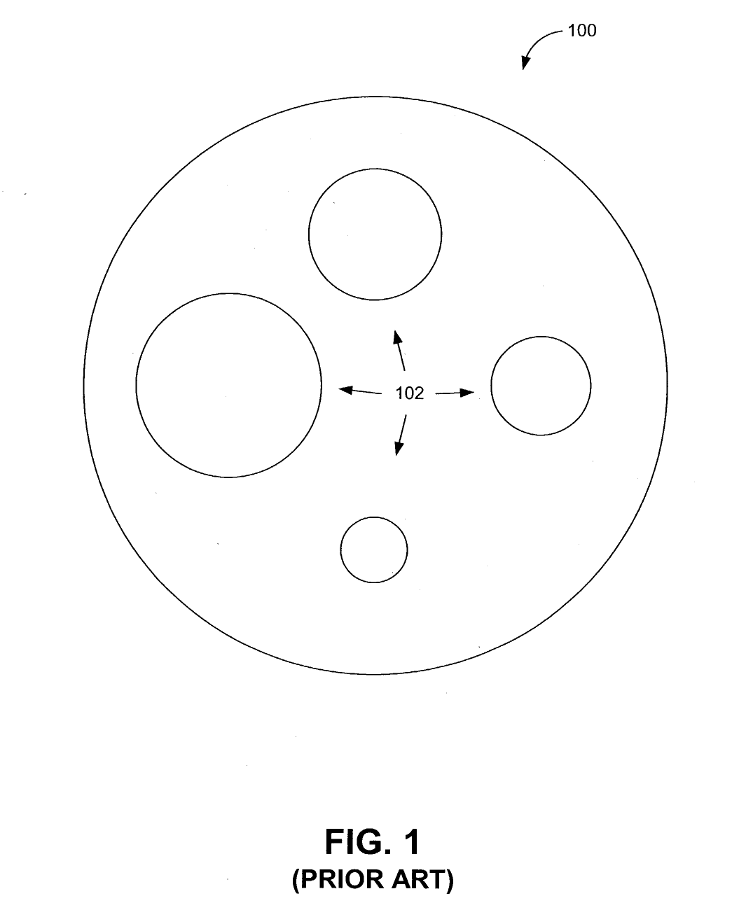

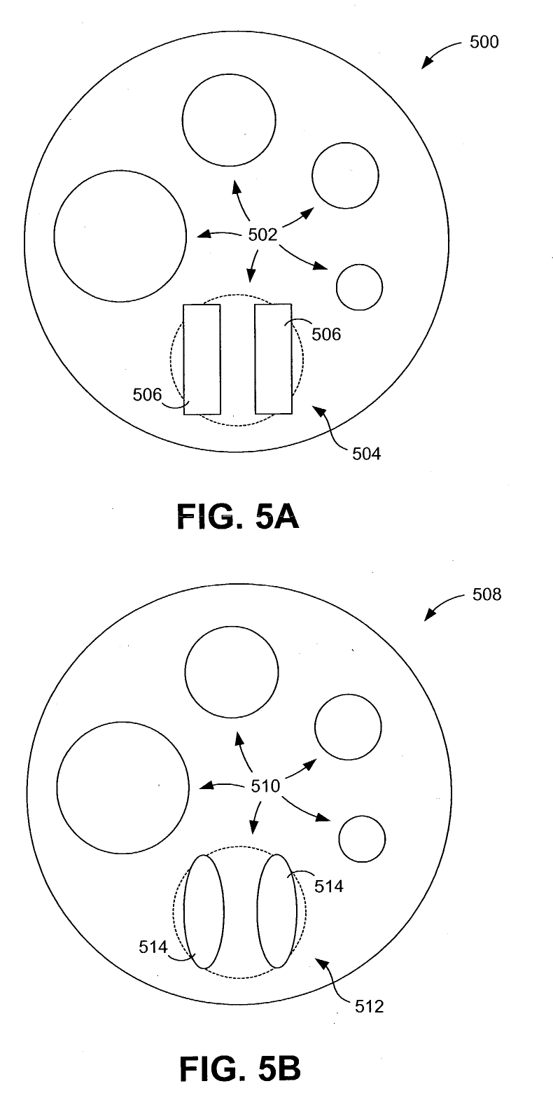

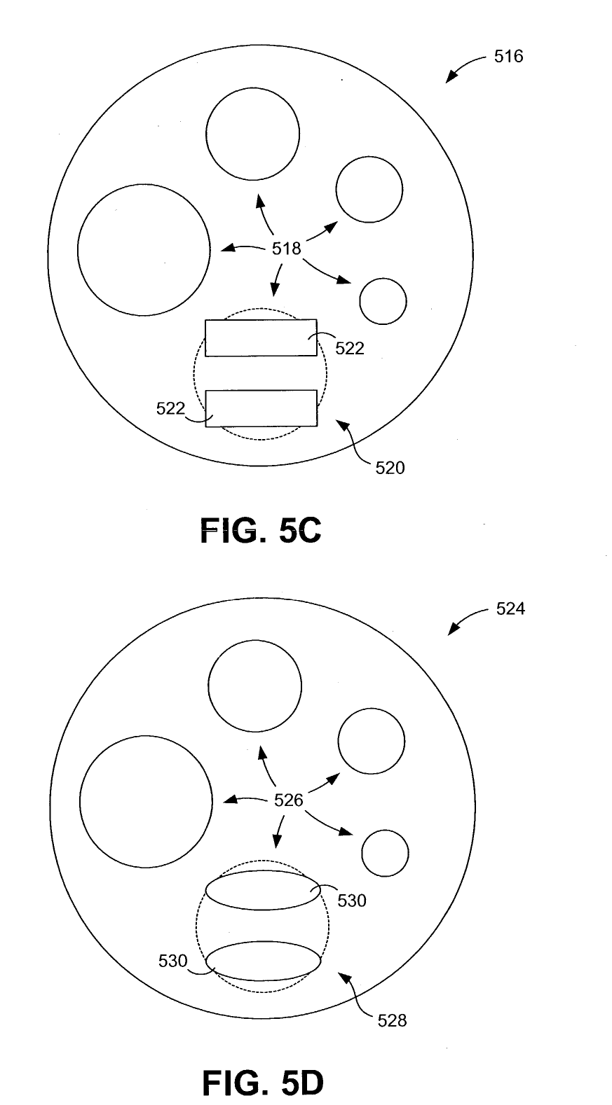

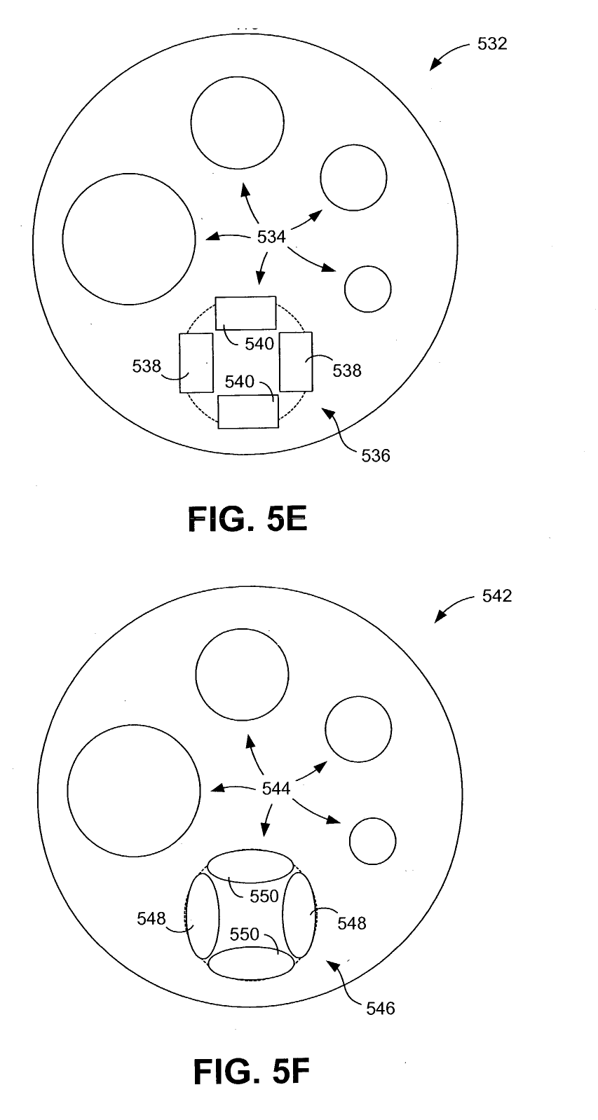

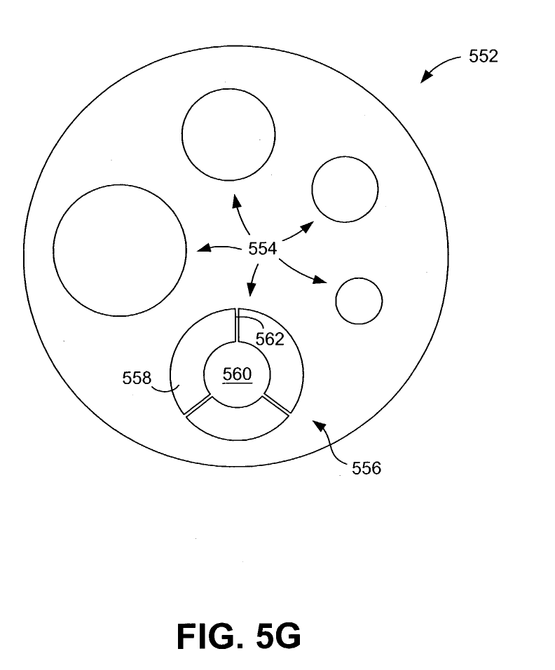

Beginning with block 300, the autofocus control 224 is activated. Such activation can occur, for example, when a user presses a shutter-release button of the camera fully or to a halfway (autofocus) position. In any case, once the autofocus control 224 is activated, the aperture member 204 is actuated to align an autofocus aperture of the member with the light path that extends within the camera from the camera lens system and the image sensor (block 302). As is described in greater detail below, the autofocus aperture is a non-circular aperture that is specifically designed for use in the autofocus process to prevent light collected from the central portion of the camera lens (or lens system) from being used in the focus determination such that the determination is made only from light collected from the periphery of the lens. As used herein, the term “non-circular” is used to distinguish over single, unobstructed circular openings, such as the aperture openings 102 shown in FIG. 1. Examples of suitable non-circular apertures are provided in FIGS. 5A-5G.

FIG. 4 depicts alignment of an autofocus aperture with the camera light path described above. As indicated in FIG. 4, light that is collected by a lens 400 is transmitted along a light path L toward an image sensor 402 of the camera. Although a single lens 400 is shown in FIG. 4, this lens represents the one or more lenses of the camera lens system. Between the lens 400 and the sensor 402 is an aperture member 404. In the embodiment of FIG. 4, the aperture member 404 is configured as an aperture wheel that includes a plurality of apertures 406, each comprising at least one aperture opening. One of the apertures, an autofocus aperture 408, is aligned with the light path L so as to restrict the light that is delivered to the sensor 402. In the example of FIG. 4, the autofocus aperture 408 comprises two independent openings 410.

Returning to FIG. 3, light collected from the central portion of the camera lens is restricted by the autofocus aperture, as indicated in block 304, due to its placement along the light path. Therefore, only light from the periphery of the lens may reach the camera sensor. The nature of the light that reaches the camera sensor, i.e. the source from which this light originates, depends upon the configuration of the autofocus aperture that is used. FIGS. 5A-5G illustrate example aperture members, each comprising a different autofocus aperture configuration.

With reference first to FIG. 5A, illustrated is a first aperture member 500 that comprises a plurality of apertures 502, including an autofocus aperture 504. The autofocus aperture 504 comprises two horizontally-spaced, rectilinear vertical slots 506. As is indicated by a dashed line that outlines the periphery of a fully-open circular aperture, the slots 504 are positioned such that only light from the periphery, in this case the lateral edges, of the camera lens or lens system may pass. Therefore, light collected from the central portion of the lens or lens system is filtered by the autofocus aperture 504. Such a configuration may be well-suited for cameras that are configured to measure horizontal contrast during the focus determination.

Referring next to FIG. 5B, illustrated is a second aperture member 508 that comprises a plurality of apertures 510, including an autofocus aperture 512. The autofocus aperture 512 is similar to the autofocus aperture shown in FIG. 5A, but comprises two horizontally-spaced, elliptical vertical slots 514. Again, the slots 514 are positioned such that only light from the periphery, in this case the lateral edges, of the camera lens or lens system may pass.

With reference to FIG. 5C, illustrated is a third aperture member 516 that comprises a plurality of apertures 518, including an autofocus aperture 520. Unlike previously-described autofocus apertures, the autofocus aperture 520 comprises two vertically-spaced, rectilinear horizontal slots 522. As is indicated by a dashed line that outlines the periphery of a fully-open circular aperture, the slots 522 are positioned such that only light from the periphery, in this case the top and bottom edges, of the camera lens or lens system may pass, and light collected from the central portion of the lens or lens system is filtered by the autofocus aperture 520. Such a configuration may be well-suited for cameras that are configured to measure vertical contrast during the focus determination.

Referring next to FIG. 5D, illustrated is a fourth aperture member 524 that comprises a plurality of apertures 526, including an autofocus aperture 528. The autofocus aperture 528 is similar to the autofocus aperture shown in FIG. 5C, but comprises two vertically-spaced, elliptical horizontal slots 530. Again, the slots 530 are positioned such that only light from the periphery, in this case the top and bottom edges, of the camera lens or lens system may pass.

Continuing on to FIG. 5E, illustrated is a fifth aperture member 532 that comprises a plurality of apertures 534 including an autofocus aperture 536. Unlike previously-described autofocus apertures, the autofocus aperture 536 comprises four rectilinear slots: two horizontally-spaced, vertical slots 538 and two vertically-spaced, horizontal slots 540. These slots 538, 540 are positioned such that only light from the periphery, in this case the top, bottom, and lateral edges, of the camera lens or lens system may pass. Therefore, once again, light collected from the central portion of the lens or lens system is filtered by the autofocus aperture 536. Such a configuration may be well-suited for cameras that are configured to measure both horizontal and vertical contrast during the focus determination.

FIG. 5F illustrates sixth aperture member 542, which is a variant of the aperture member shown in FIG. 5E. Therefore, the aperture member 542 comprises a plurality of apertures 544, including an autofocus aperture 546. The autofocus aperture 546 is similar to the autofocus aperture shown in FIG. 5E, but its vertical slots 548 and horizontal slots 550 are elliptical rather than rectilinear.

FIG. 5G illustrates a seventh aperture member 552. The seventh aperture member 552 comprises a plurality of apertures 554, including an autofocus aperture 556. The autofocus aperture 556 comprises a ring-shaped opening 558 that is formed by a central member 560 that is positioned within the central portion of the autofocus aperture 556. By way of example, the central member 560 is round and is supported by one or more strut members 562 that extend radially outward from the central member. With this configuration, the autofocus aperture 556 filters the light collected from the central portion of the lens or lens system such that only light from the circular periphery of the lens or lens system may pass. Such a configuration may be well-suited for cameras that are configured to measure both horizontal and vertical contrast during the focus determination.

In the foregoing figures, several example aperture members have been depicted. Although each of these members has been shown as being configured as an aperture wheel that includes a plurality of different apertures, it is noted that the aperture members need not be configured in this manner. Instead, the aperture members need only comprise an appropriate autofocus aperture and be configured such that the autofocus aperture can be positioned along the camera light path in a manner in which light from the central portion of the lens or lens system is filtered. Moreover, more than one autofocus aperture may be provided on the aperture member, if desired.

Returning once again to FIG. 3, the autofocus control 224 next determines the focus position in which the viewed scene is most in focus, as indicated in block 306. This step involves moving the camera lens or lens system (or one or more elements or groups of elements within the lens system) axially between several different focus positions, and evaluating the sharpness (i.e., observed contrast) of the viewed scene at each position. Focus values are derived for each focus position and the results are compared to determine the focus position at which the image is most in focus. The focus value that is derived for each focus position may be a measure of horizontal contrast, vertical contrast, or some combination of the two.

Because of the provision of the autofocus aperture and its insertion into the light path between the camera lens or lens system and the image sensor, the focus determination is made only in reference to light collected from the periphery of the lens or lens system. Therefore, only the light signals that contain the most information as to the focus of the image are used during the focus determination, thereby resulting in a more accurate autofocus process. Notably, an autofocus zone typically used in making the autofocus determination, for instance the central portion of the camera frame, may be used in the autofocus method described herein in that the autofocus aperture, and each opening of this aperture, allows light from the entire observed scene to reach the image sensor. However, in that this light is collected from the periphery of the lens or lens system, more accurate determinations are made.

What is claimed is:

1. A method for determining the focus of an image, comprising:
restricting light provided by a central portion of a camera lens so that light is primarily collected from a periphery of the lens; and
evaluating the focus of the image using the light from the periphery of the lens.

2. The method of claim 1, wherein restricting light comprises restricting light using a non-circular autofocus aperture.

3. The method of claim 2, wherein restricting light using a non-circular autofocus aperture comprises restricting light using at least one vertical slot positioned so as to allow light collected from the periphery of the lens to pass.

4. The method of claim 2, wherein restricting light using a non-circular autofocus aperture comprises restricting light using at least one horizontal slot positioned so as to allow light collected from the periphery of the lens to pass.

5. The method of claim 2, wherein restricting light using a non-circular autofocus aperture comprises restricting light using a ring-shaped opening.

6. The method of claim 1, wherein evaluating the focus of the image comprises moving the camera lens axially between several different focus positions and evaluating the sharpness of the image at each position.

7. The method of claim 6, wherein evaluating the focus of the image further comprises deriving focus values for each focus position and comparing the focus values to identify the focus position at which the image is most in focus.

8. A system for determining the focus, comprising:
a lens system comprising at least one lens that collects light from a viewed scene;
an aperture member that is configured to restrict the passage of light collected from a central portion of the at least one lens so that light is primarily collected from a periphery of the at least one lens; and
an autofocus control that is configured to determine the focus of an image of the viewed scene using the light collected from a periphery of the at least one lens.

9. The system of claim 8, wherein the aperture member comprises an non-circular autofocus aperture.

10. The system of claim 9, wherein the non-circular autofocus aperture comprises at least one vertical slot positioned on the aperture member so as to only allow light collected from the periphery of the lens to pass.

11. The system of claim 9, wherein the non-circular autofocus aperture comprises at least one horizontal slot positioned on the aperture member so as to allow light collected from the periphery of the lens to pass.

12. The system of claim 9, wherein the non-circular autofocus aperture comprises a ring-shaped opening.

13. An autofocus system, comprising:
means for restricting light provided by a central portion of a camera lens but allowing light collected from a periphery of the lens to pass; and
means for determining the focus of an image using the light from the periphery of the lens.

14. The system of claim 13, wherein the means for restricting light comprise a non-circular autofocus aperture.

15. The system of claim 13, wherein the means for restricting light comprise at least one vertical slot.

16. The system of claim 13, wherein the means for restricting light comprise at least one horizontal slot.

17. The system of claim 13, wherein the means for restricting light comprise a ring-shaped opening.

18. The system of claim 13, wherein the means for determining the focus of an image comprise means for determining a focus value at each of several different focus positions.

19. An aperture member for use in a camera, the member comprising:
a non-circular autofocus aperture that is configured to restrict the passage of light provided by a central portion of a camera lens;
wherein the non-circular autofocus aperture allows light provided by a periphery of the camera lens to pass.

20. The aperture member of claim 19, wherein the non-circular autofocus aperture comprises at least one slot.

21. The aperture member of claim 20, wherein the non-circular autofocus aperture comprises two slots.

22. The aperture member of claim 20, wherein the at least one slot is vertically-oriented.

23. The aperture member of claim 20, wherein the at least one slot is horizontally-oriented.

24. The aperture member of claim 20, wherein the at least one slot is rectilinear.

25. The aperture member of claim 20, wherein the at least one slot is elliptical.

26. The aperture member of claim 19, wherein the non-circular autofocus aperture comprises a ring-shaped opening.

27. A camera, comprising:
an image sensor that detects light signals;
a lens system including at least one lens, the lens system being configured to transmit light toward the image sensor;
an aperture member that is positioned between the lens system and the image sensor, the aperture member being configured to restrict the passage of light collected from a central portion of the at least one lens so that light is primarily collected from a periphery of the at least one lens and reaches the image sensor; and
an autofocus control that is configured to determine the focus of an image of the viewed scene using the light collected from a periphery of the at least one lens.
